(19) United States
(12) Patent Application Publication
(10) Pub. No.: US 2014/0026019 A1
(43) Pub. Date: Jan. 23, 2014

(54) INFORMATION PROCESSING SYSTEM, SHARED MEMORY DEVICE, AND METHOD FOR SAVING MEMORY DATA

(71) Applicant: FUJITSU LIMITED, Kawasaki-shi (JP)

(72) Inventor: Yusuke SAWADA, Yokohama (JP)

(73) Assignee: FUJITSU LIMITED, Kawasaki-shi (JP)

(21) Appl. No.: 14/032,591

(22) Filed: Sep. 20, 2013

Related U.S. Application Data
(63) Continuation of application No. PCT/JP2011/056854, filed on Mar. 22, 2011.

(51) Int. Cl. G06F 11/10

(52) U.S. Cl. CPC G06F 11/1068
USPC 714/773

(57) ABSTRACT

An information processing system includes a plurality of clusters and a shared memory device having a shared memory shared by computer programs that operate on the clusters. The shared memory device includes an operating system (OS) stop detecting unit and a solid state drive (SSD) control unit. The OS stop detecting unit detects stop of computer programs that operate on all the clusters allocated to a certain storage area among storage areas of the shared memory shared by the clusters during an operation of the system. The SSD control unit saves, when the OS stop detecting unit detects the stop of the computer programs that operate on all the clusters allocated to the certain storage area, data stored in the certain storage area to a nonvolatile storage area. The information processing system can reduce time required to save data stored in the shared memory device when a power failure occurs.

### CROSS-REFERENCE TO RELATED APPLICATION

This application is a continuation of International Application No. PCT/JP2011/056854, filed on Mar. 22, 2011, the entire contents of which are incorporated herein by reference.

### FIELD

The embodiments discussed herein are directed to an information processing system, a shared memory device, and a method for saving memory data.

### BACKGROUND

There have been developed information processing systems including a plurality of server devices and a shared memory device. A shared memory device included in information processing systems has a volatile memory area divided into a plurality of logical partitions (hereinafter, referred to as sections). The memory area of each section is used by a server device allocated to the section.

A cut-off of power supply due to a power failure prevents such a shared memory device to retain data on its memory areas. To address this, the shared memory device is supplied with power from an auxiliary power supply (UPS: an uninterruptible power supply) when a power failure occurs, thereby retaining data on the memory areas. Thus, the shared memory device backs up data stored in all the sections to a nonvolatile storage device. Conventional examples are described in Japanese Laid-open Patent Publication No. 2001-92738, Japanese Laid-open Patent Publication No. 02-278457, and Japanese Laid-open Patent Publication No. 04-283810.

It takes time for a shared memory device to back up data stored in all the sections on its memory area to a nonvolatile storage device when a power failure occurs.

### SUMMARY

According to an aspect of an embodiment, an information processing system includes a plurality of information processing apparatuses and a shared memory device including a shared memory shared by computer programs that operate on the information processing apparatuses. The shared memory device includes a detecting unit and a saving unit. The detecting unit detects stop of computer programs that operate on all information processing apparatuses allocated to a certain storage area among storage areas of the shared memory shared by the information processing apparatuses during an operation of the information processing system. The saving unit saves, when the detecting unit detects the stop of the computer programs that operate on all the information processing apparatuses allocated to the certain storage area, data stored in the certain storage area to a nonvolatile storage area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram of a configuration of an information processing system according to a first embodiment;

FIG. 2 is a flowchart of a process performed by a CL control unit (CL-SVP) when OSs are stopped according to the first embodiment;

FIG. 3 is a flowchart of a process performed by an SSU control unit (SSU-SVP) when the OSs are stopped according to the first embodiment;

FIG. 4 is a flowchart of a process performed by the SSU-SVP when a power failure occurs according to the first embodiment;

FIG. 5 is a view for explaining a data flow when the OSs are stopped according to the first embodiment;

FIG. 6 is a view for explaining a data flow when a power failure occurs according to the first embodiment;

FIG. 7 is a diagram of a sequence performed when the OSs are stopped according to the first embodiment;

FIG. 8 is a functional block diagram of a configuration of an information processing system according to a second embodiment;

FIG. 9 is a flowchart of a process performed by an SSU-SVP when OSs are stopped according to the second embodiment;

FIG. 10 is a flowchart of a process performed by the SSU-SVP when a power failure occurs according to the second embodiment;

FIG. 11 is a view for explaining a data flow when the OSs are stopped according to the second embodiment;

FIG. 12 is a view for explaining a data flow when a power failure occurs according to the second embodiment; and

FIG. 13 is a diagram of a sequence performed when the OSs are stopped according to the second embodiment.

### DESCRIPTION OF EMBODIMENTS

Preferred embodiments of the present invention will be explained with reference to accompanying drawings. In the embodiments, the present invention is applied to an information processing system including a plurality of large server devices (hereinafter, referred to as clusters) and a shared memory device. The present invention, however, is not limited to the embodiments and is also applicable to a massively parallel computer system and a super computer system.

### [a] First Embodiment

Configuration of Information Processing System According to First Embodiment

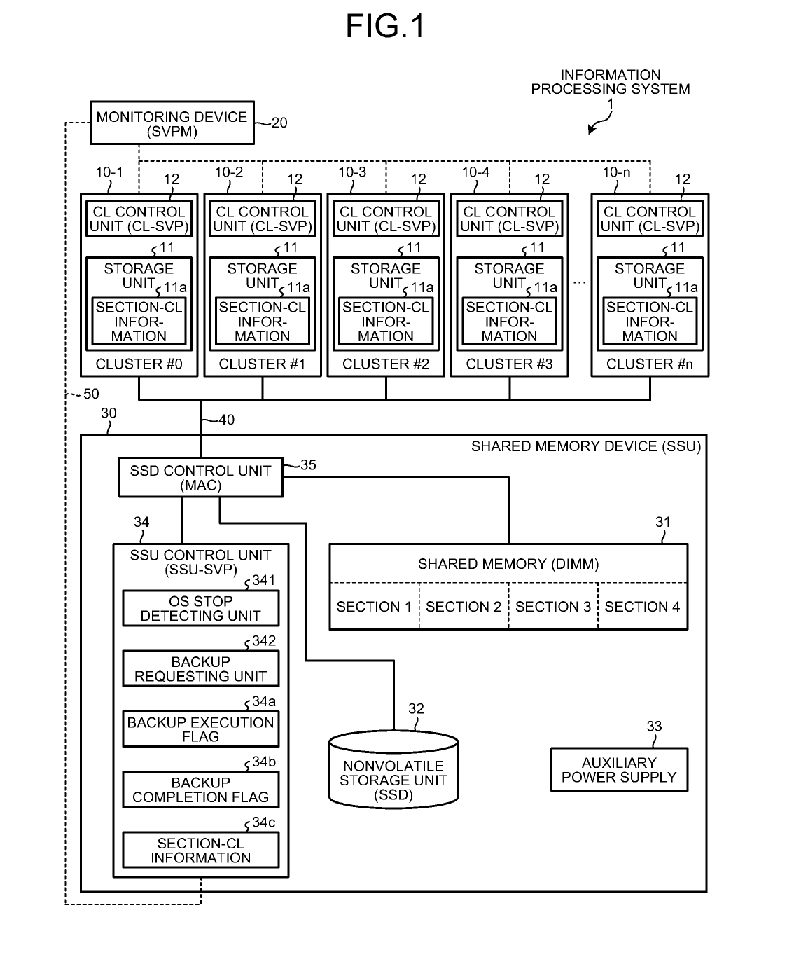

FIG. 1 is a functional block diagram of a configuration of an information processing system 1 according to a first embodiment. As illustrated in FIG. 1, the information processing system 1 includes a plurality of clusters 10-1 to 10-n (n is an integer larger than 1, and the same applies to the following), a monitoring device 20, and a shared memory device 30. The clusters 10-1 to 10-n and the shared memory device 30 are connected via a data communication line (XAUI: a 10-gigabit Ethernet (registered trademark) attachment unit interface) 40.

The clusters 10-1 to 10-n are large server devices. The clusters 10-1 to 10-n each use a storage area allocated thereto in a shared memory (DIMM: a dual inline memory module) 31 of the shared memory device 30. The shared memory 31 is partitioned into a plurality of storage areas, which are referred to as sections. In other words, the clusters 10-1 to 10-n each use a section allocated thereto in the shared memory 31.

The clusters 10-1 to 10-n each have a storage unit 11 and a CL control unit (CL-SVP: a cluster-service processor) 12. The storage unit 11 has section-CL information 11a. The section-CL information 11a associates the clusters 10-1 to 10-n with respective sections allocated thereto. The section-CL information 11a, for example, stores therein the identification numbers of the clusters 10-1 to 10-n in a manner associated with the identification numbers of the respective sections allocated thereto. The sections allocated to the clusters may differ depending on the clusters. Alternatively, the same section may be allocated to different clusters. In the description below, the same section may be allocated to different clusters. The storage unit 11 is a semiconductor memory element, such as a random access memory (RAM) and a flash memory, or a storage device, such as a hard disk and an optical disk, for example.

The CL control unit 12 controls the cluster main body. If the CL control unit 12 receives a stop instruction for an operating system (OS), for example, the CL control unit 12 inquires of all the clusters 10 (10-1 to 10-n) allocated to the same section as that for its own cluster whether the OS is operating based on the section-CL information 11a. If the OSs of all the clusters 10 allocated to the same section as that for its own cluster are stopped, the CL control unit 12 transmits a backup instruction for the section to the shared memory device 30. By contrast, if any one of the OSs of the clusters 10 allocated to the same section as that for its own cluster is operating, the CL control unit 12 transmits no backup instruction for the section. The CL control unit 12 shuts down the OS operating on its own cluster.

The functions of the CL control unit 12, for example, can be carried out by an integrated circuit, such as an application specific integrated circuit (ASIC) and a field programmable gate array (FPGA). The functions of the CL control unit 12 can be carried out by a predetermined computer program causing a central processing unit (CPU) to operate.

The monitoring device (SVPM: a service processor manager) 20 is connected to the clusters 10-1 to 10-n and the shared memory device 30 via a maintenance line (LAN: a local area network) 50. The monitoring device 20 collectively controls the information processing system 1 and monitors the operating state of the clusters 10-1 to 10-n and the shared memory device 30. The monitoring device 20, for example, transmits a stop instruction for an OS to a specific cluster 10.

The shared memory device (SSU: a system storage unit) 30 is a device including a shared memory shared by the OSs operating on the clusters 10-1 to 10-n. The shared memory device 30 further includes the shared memory (DIMM) 31, a nonvolatile storage unit 32, an auxiliary power supply 33, an SSU control unit 34, and an SSD control unit 35. The shared memory 31 is a volatile memory that loses data stored therein in the case where no power is supplied from a power source because of a power failure. The shared memory 31 is partitioned into a plurality of logical memory areas (sections). The memory area of each section is available only to the cluster 10 allocated to the section. If the OSs of all the clusters 10 allocated to a certain section stop operating, the memory area of the section is kept from being accessed. As a result, the data stored in the section is not rewritten. The shared memory device 30 backs up the data stored in the memory area of the certain section to a nonvolatile storage area at a timing when the OSs of all the clusters 10 allocated to the section stop operating. Thus, the shared memory device 30 can reduce the amount of data in the shared memory 31 backed up when a power failure occurs.

The nonvolatile storage unit (SSD: a solid state drive) 32 is a storage area that loses no data stored therein even if no power is supplied from the power source. The nonvolatile storage unit 32 includes a semiconductor memory element, such as a flash memory, or a storage medium, such as a hard disk and an optical disk, for example. The auxiliary power supply 33 supplies auxiliary power instead of a main power supply when a power failure occurs. The auxiliary power supply 33 includes an uninterruptible power supply (UPS), for example.

The SSU control unit (SSU-SVP) 34 controls the main body of the SSU 30. The SSU control unit 34 includes an OS stop detecting unit 341, a backup requesting unit 342, a backup execution flag 34a, a backup completion flag 34b, and section-CL information 34c. The functions of the SSU control unit 34, for example, can be carried out by an integrated circuit, such as an ASIC and an FPGA. The functions of the SSU control unit 34 can be carried out by a predetermined computer program causing the CPU to operate.

During an operation of the system, the OS stop detecting unit 341 detects the stop of the OSs operating on all the clusters 10 allocated to a certain section among the sections of the shared memory 31 shared by the clusters 10-1 to 10-n. The OS stop detecting unit 341, for example, receives a backup instruction for a section from any of the clusters 10. As a result, the OS stop detecting unit 341 detects the stop of the OSs of all the clusters 10 allocated to the same section as the section allocated to the cluster 10 that instructs the backup.

The backup requesting unit 342 requests the SSD control unit 35 to back up the section related to the detection based on the backup execution flag 34a and the backup completion flag 34b of the section. The backup execution flag 34a is information used to determine whether a backup of each section is being executed. The backup execution flag 34a, for example, stores therein a flag indicating whether a backup is being executed in association with the identification number of each section. If a backup is being executed (data is being saved), “ON” is stored in the flag. If no backup is being executed, “OFF” is stored in the flag. The backup completion flag 34b is information used to determine whether a backup of each section is completed. The backup completion flag 34b, for example, stores therein a flag indicating whether a backup is completed in association with the identification number of each section. If a backup is completed, “ON” indicating that the backup is completed (data is saved) is stored in the flag. If a backup is not completed yet, “OFF” is stored in the flag.

If both the backup execution flag 34a and the backup completion flag 34b of the section for which a backup instruction is issued are set to “OFF”, for example, the backup requesting unit 342 turns “ON” the backup execution flag 34a. The backup requesting unit 342 then instructs the SSD control unit 35 to back up the section for which the backup instruction is issued. If a completion notification of the backup is received from the SSD control unit 35, the backup requesting unit 342 turns “OFF” the backup execution flag 34a of the section for which the backup is completed. In addition, the backup requesting unit 342 turns “ON” the backup completion flag 34b of the section for which the backup is completed.

If a notification of detection of a power failure is received, the backup requesting unit 342 activates the auxiliary power supply 33. As a result, the shared memory device 30 is supplied with power by the auxiliary power supply 33 even in the power failure. The backup requesting unit 342 requests the SSD control unit 35 to back up an appropriate section based on the backup execution flags 34a and the backup completion flags 34b of all the sections. The backup requesting unit 342, for example, turns “ON” the backup execution flag 34a of a section whose backup execution flag 34a and backup completion flag 34b are set to “OFF”. The backup requesting unit 342 then instructs the SSD control unit 35 to back up the section whose backup execution flag 34a is turned “ON”. If a completion notification of the backup is received from the SSD control unit 35, the backup requesting unit 342 turns “OFF” the backup execution flag 34a of the section for which the backup is completed. In addition, the backup requesting unit 342 turns “ON” the backup completion flag 34b of the section for which the backup is completed.

The section-CL information 34c associates each cluster with a section allocated thereto. The section-CL information 34c is the same information as the section-CL information 11a stored in the respective storage units 11 of the clusters 10-1 to 10-n. The section-CL information 34c is set at the start of an operation of the system, for example.

The SSD control unit (MAC) 35 executes a backup of a section requested by the backup requesting unit 342. Specifically, if a request for a backup is received from the backup requesting unit 342, the SSD control unit 35 reads data of the section serving as a target of the backup thus requested from the shared memory 31. The SSD control unit 35 then stores the data thus read in the nonvolatile storage unit 32. The SSD control unit 35 notifies the backup requesting unit 342 of completion of the backup of the section for which the backup is completed.

Process Performed by CL Control Unit (CL-SVP) When OSs Are Stopped according to First Embodiment

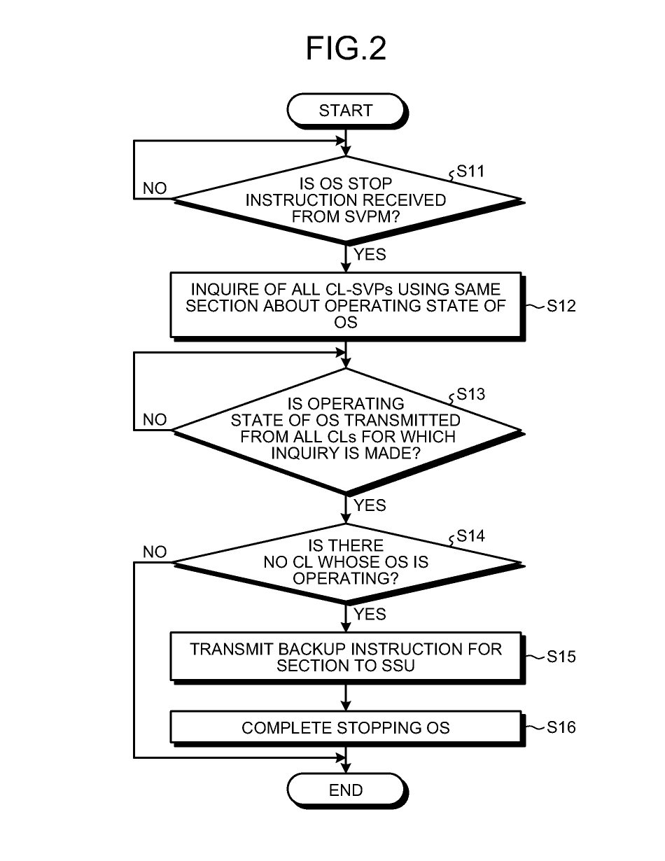

The following describes a process performed by the CL control unit (CL-SVP) 12 when OSs are stopped according to the first embodiment with reference to FIG. 2. FIG. 2 is a flowchart of a process performed by the CL control unit (CL-SVP) when OSs are stopped according to the first embodiment.

The CL-SVP 12 determines whether a stop instruction for an OS is received from the monitoring device (SVPM) 20 (Step S11). If it is determined that no stop instruction for an OS is received (No at Step S11), the CL-SVP 12 repeats the determination processing until a stop instruction of an OS is received. By contrast, if it is determined that a stop instruction for an OS is received (Yes at Step S11), the CL-SVP 12 inquires of the CL-SVPs 12 of all the clusters (hereinafter, simply referred to as “CL”) using the same section as that for its own CL about the operating state of the OSs (Step S12).

The CL-SVP 12 determines whether the operating state of the OS is transmitted from the CL-SVPs 12 of all the CLs for which the inquiry is made (Step S13). If it is determined that the operating state of the OSs is not transmitted yet from the CL-SVPs 12 of all the CLs (No at Step S13), the CL-SVP 12 repeats the determination processing until the operating state of the OSs is transmitted from the CL-SVPs 12 of all the CLs.

By contrast, if it is determined that the operating state of the OSs is transmitted from the CL-SVPs 12 of all the CLs (Yes at Step S13), the CL-SVP 12 determines whether there is no CL whose OS is operating among the CLs for which the inquiry is made (Step S14). If it is determined that there is a CL whose OS is operating (No at Step S14), the CL-SVP 12 transmits no backup instruction for the section.

By contrast, if it is determined that there is no CL whose OS is operating (Yes at Step S14), the CL-SVP 12 transmits a backup instruction for the section serving as the target to the shared memory device (SSU) 30 (Step S15). The CL-SVP 12 completes stopping the OS (Step S16).

Process Performed by SSU Control Unit (SSU-SVP) When OSs Are Stopped According to First Embodiment

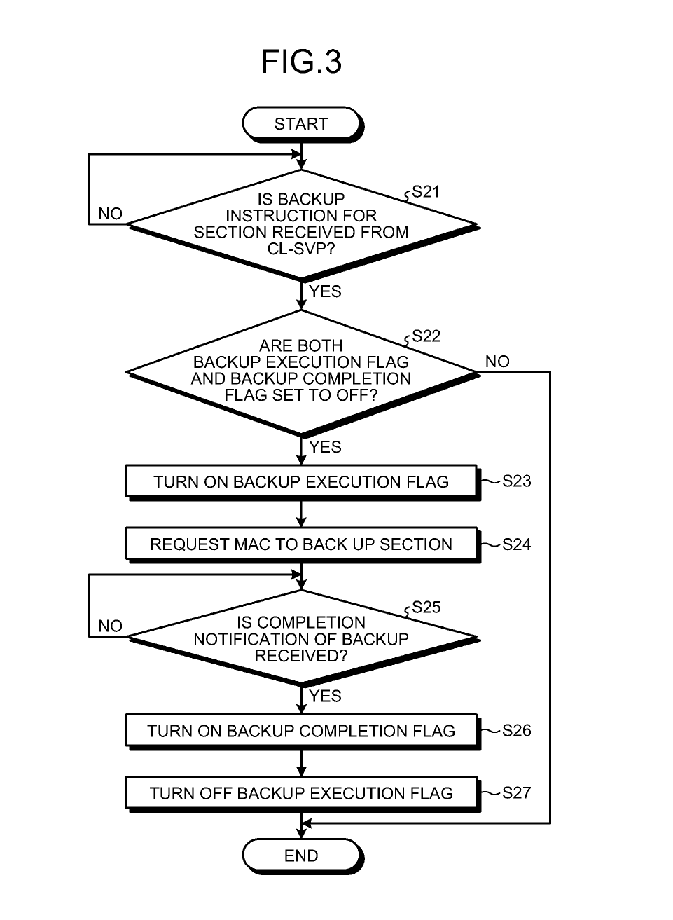

The following describes a process performed by the SSU control unit (SSU-SVP) 34 when the OSs are stopped according to the first embodiment with reference to FIG. 3. FIG. 3 is a flowchart of a process performed by the SSU control unit (SSU-SVP) when the OSs are stopped according to the first embodiment.

The OS stop detecting unit 341 of the SSU-SVP 34 determines whether a backup instruction for a section is received from the CL-SVP 12 (Step S21). If it is determined that no backup instruction for a section is received (No at Step S21), the OS stop detecting unit 341 repeats the determination processing until a backup instruction for a section is received. By contrast, if it is determined that a backup instruction for a section is received (Yes at Step S21), the OS stop detecting unit 341 detects that the OSs of all the clusters 10 allocated to the section are stopped.

Subsequently, the backup requesting unit 342 determines whether both the backup execution flag 34a and the backup completion flag 34b of the section for which the backup instruction is issued are set to OFF (Step S22). If both the backup execution flag 34a and the backup completion flag 34b are not set to OFF (No at Step S22), the backup requesting unit 342 is executing a backup or completes a backup. Thus, the processing is terminated.

By contrast, if both the backup execution flag 34a and the backup completion flag 34b are set to OFF (Yes at Step S22), the backup requesting unit 342 turns “ON” the backup execution flag 34a of the section for which the backup instruction is issued (Step S23). The backup requesting unit 342 then requests the SSD control unit 35 to back up the section for which the backup instruction is issued (Step S24).

Subsequently, the backup requesting unit 342 determines whether a completion notification of the backup of the section serving as the target of the backup is received (Step S25). If it is determined that no completion notification of the backup is received (No at Step S25), the backup requesting unit 342 repeats the determination processing until a completion notification of the backup is received. By contrast, if it is determined that a completion notification of the backup is received (Yes at Step S25), the backup requesting unit 342 turns “ON” the backup completion flag of the section serving as the target of the backup (Step S26). The backup requesting unit 342 then turns “OFF” the backup execution flag of the section serving as the target of the backup (Step S27).

Process Performed by SSU Control Unit (SSU-SVP) When Power Failure Occurs According to First Embodiment

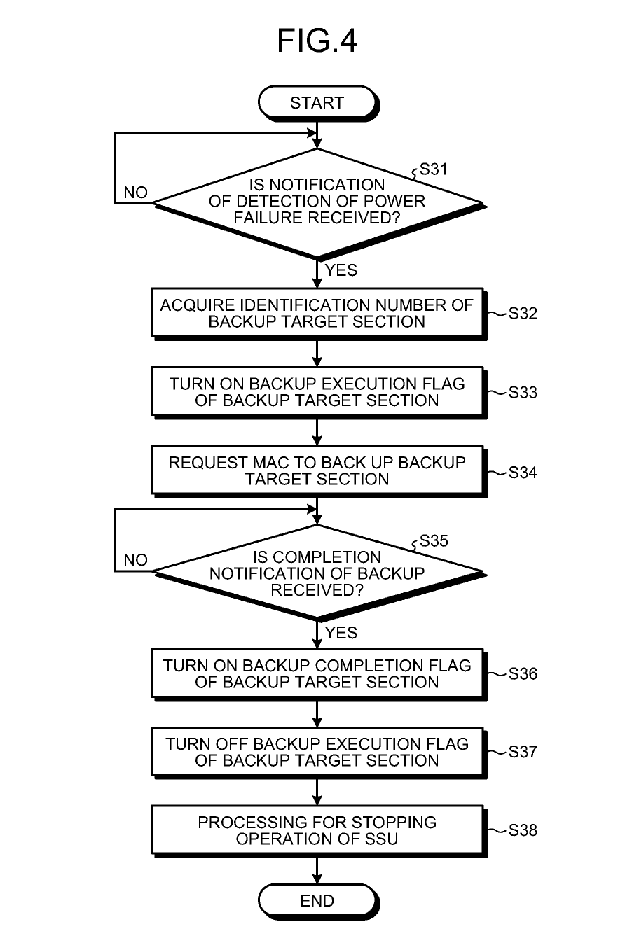

The following describes a process performed by the SSU control unit (SSU-SVP) 34 when a power failure occurs according to the first embodiment with reference to FIG. 4. FIG. 4 is a flowchart of a process performed by the SSU control unit (SSU-SVP) when a power failure occurs according to the first embodiment.

The backup requesting unit 342 of the SSU-SVP 34 determines whether a notification of detection of a power failure is received (Step S31). If it is determined that no notification of detection of a power failure is received (No at Step S31), the backup requesting unit 342 repeats the determination processing until a notification of detection of a power failure is received.

By contrast, if it is determined that a notification of detection of a power failure is received (Yes at Step S31), the backup requesting unit 342 activates the auxiliary power supply 33. After the activation, the backup requesting unit 342 acquires the identification number of a section serving as a target of a backup (Step S32). The backup requesting unit 342, for example, acquires the identification number of a section whose backup execution flag 34a and backup completion flag 34b are set to “OFF”.

The backup requesting unit 342 turns “ON” the backup execution flag of the section (backup target section) corresponding to the identification number thus acquired (Step S33). The backup requesting unit 342 then requests the SSD control unit (MAC) 35 to back up the backup target section (Step S34).

Subsequently, the backup requesting unit 342 determines whether a completion notification of the backup of the backup target section is received (Step S35). If it is determined that no completion notification of the backup is received (No at Step S35), the backup requesting unit 342 repeats the determination processing until a completion notification of the backup is received. By contrast, if it is determined that a completion notification of the backup is received (Yes at Step S35), the backup requesting unit 342 turns “ON” the backup completion flag of the backup target section (Step S36).

The backup requesting unit 342 then turns “OFF” the backup execution flag of the backup target section (Step S37). Subsequently, the backup requesting unit 342 performs processing for stopping the operation of the SSU (Step S38).

Data Flow When OSs Are Stopped according to First Embodiment

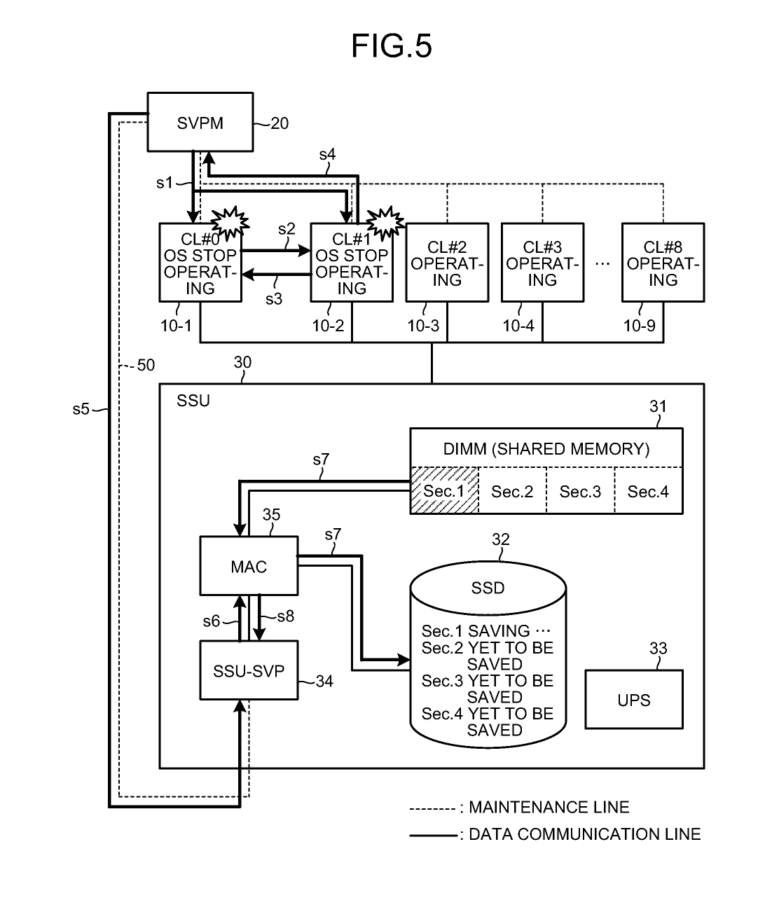

The following describes a data flow when the OSs are stopped according to the first embodiment with reference to FIG. 5. FIG. 5 is a view for explaining a data flow when the OSs are stopped according to the first embodiment. In the example of FIG. 5, the cluster 10-1 (CL #0) and a cluster 10-2 (CL #1) are allocated to the same section 1 (Sec. 1) in the shared memory 31. The backup execution flags 34a and the backup completion flags 34b of all the sections are set to “OFF”.

The monitoring device (SVPM) 20 transmits a stop instruction for the OS to the CL control units (CL-SVPs) 12 of the cluster 10-1 (CL #0) and the cluster 10-2 (CL #1) (s1). The CL-SVP 12 of the CL #0 inquires of all the CLs allocated to the same section as that for its own CL whether the OS is operating (s2). Specifically, the CL-SVP 12 of the CL #0 inquires of the CL #1 allocated to the same section 1 whether the OS is operating. The CL-SVP 12 of the CL #0 finds that the OS of the CL #1 is operating. Subsequently, the CL-SVP 12 of the CL #0 stops the OS.

The CL-SVP 12 of the CL #1 inquires of all the CLs allocated to the same section as that for its own CL whether the OS is operating (s3). Specifically, the CL-SVP 12 of the CL #1 inquires of the CL #0 allocated to the same section 1 whether the OS is operating. The CL-SVP 12 of the CL #1 finds that the OS of the CL #0 is already stopped. This keeps the data stored in the section 1 of the shared memory 31 from being accessed. The CL-SVP 12 of the CL #1 transmits a backup instruction for the section 1 to the shared memory device (SSU) 30 via the SVPM 20 (s4 and s5). Subsequently, the CL-SVP 12 of the CL #1 stops the OS.

If the backup instruction for the section 1 is received from the CL #1, the SSU control unit (SSU-SVP) 34 of the SSU 30 checks that the backup execution flag 34a and the backup completion flag 34b of the section 1 are set to “OFF”. Because the backup execution flag 34a and the backup completion flag 34b of the section 1 are set to “OFF”, the SSU-SVP 34 turns “ON” the backup execution flag 34a of the section 1. The SSU-SVP 34 then transmits the backup instruction for the section 1 to the SSD control unit (MAC) 35 (s6).

If the backup instruction for the section 1 is received, the MAC 35 backs up the data stored in the section 1 of the shared memory 31 to the nonvolatile storage unit (SSD) 32 (s7). After the backup is completed, the MAC 35 transmits a completion notification of the backup of the section 1 to the SSU-SVP 34 (s8). After receiving the completion notification of the backup, the SSU-SVP 34 turns “ON” the backup completion flag 34b of the section 1 and turns “OFF” the backup execution flag 34a of the section 1.

Data Flow When Power Failure Occurs According to First Embodiment

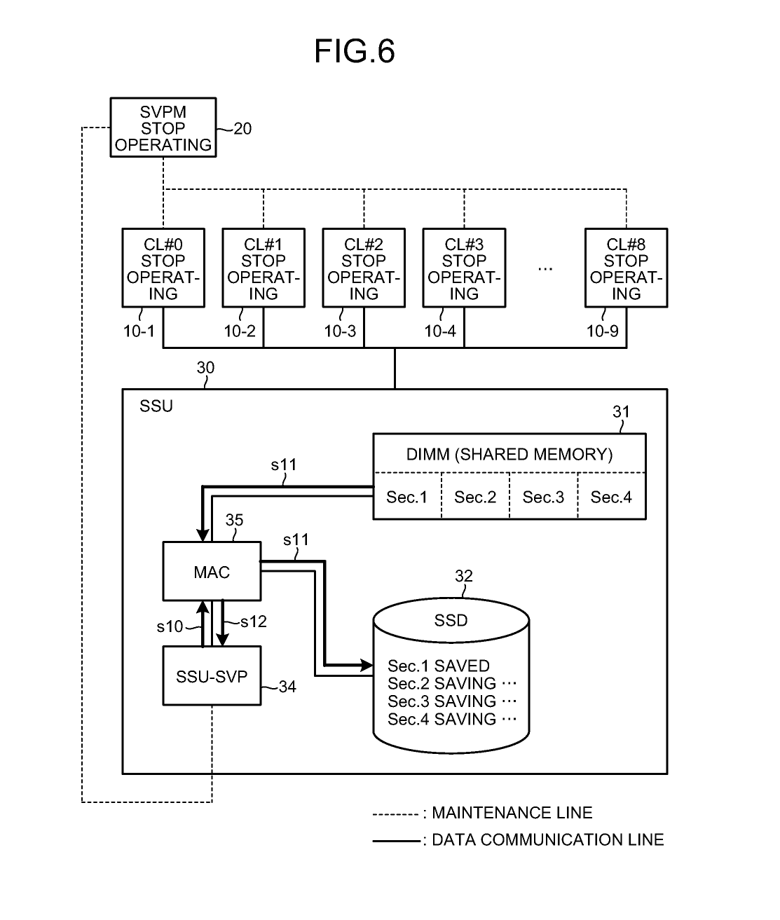

The following describes a data flow when a power failure occurs according to the first embodiment with reference to FIG. 6. FIG. 6 is a view for explaining a data flow when a power failure occurs according to the first embodiment. In the example of FIG. 6, the backup completion flag 34b of the section 1 (Sec. 1) is set to “ON”, which indicates that “data is saved”, and the backup completion flags 34b of the sections other than the section 1 are set to “OFF”. The backup execution flags 34a of all the sections are set to “OFF”.

If a power failure occurs, the SSU control unit (SSU-SVP) 34 of the SSU 30 receives a notification that the power failure is detected. Because the backup execution flags 34a and the backup completion flags 34b of the sections other than the section 1 are set to “OFF”, the SSU-SVP 34 acquires sections 2, 3, and 4 other than the section 1. The SSU-SVP 34 turns “ON” the backup execution flags 34a of the sections 2, 3, and 4 and transmits a backup instruction for the sections to the SSD control unit (MAC) 35 (s10).

If the backup instruction for the sections 2, 3, and 4 is received, the MAC 35 reads data stored in these sections from the shared memory 31 and backs up the data thus read to the data nonvolatile storage unit (SSD) 32 (s11). After the backup is completed, the MAC 35 transmits a completion notification of the backup of the sections 2, 3, and 4 to the SSU-SVP 34 (s12). After receiving the completion notification of the backup, the SSU-SVP 34 turns “ON” the backup completion flags 34b of the sections 2, 3, and 4 and turns “OFF” the backup execution flags 34a of the sections. Subsequently, the SSU-SVP 34 stops operating.

Sequence When OSs Are Stopped According to First Embodiment

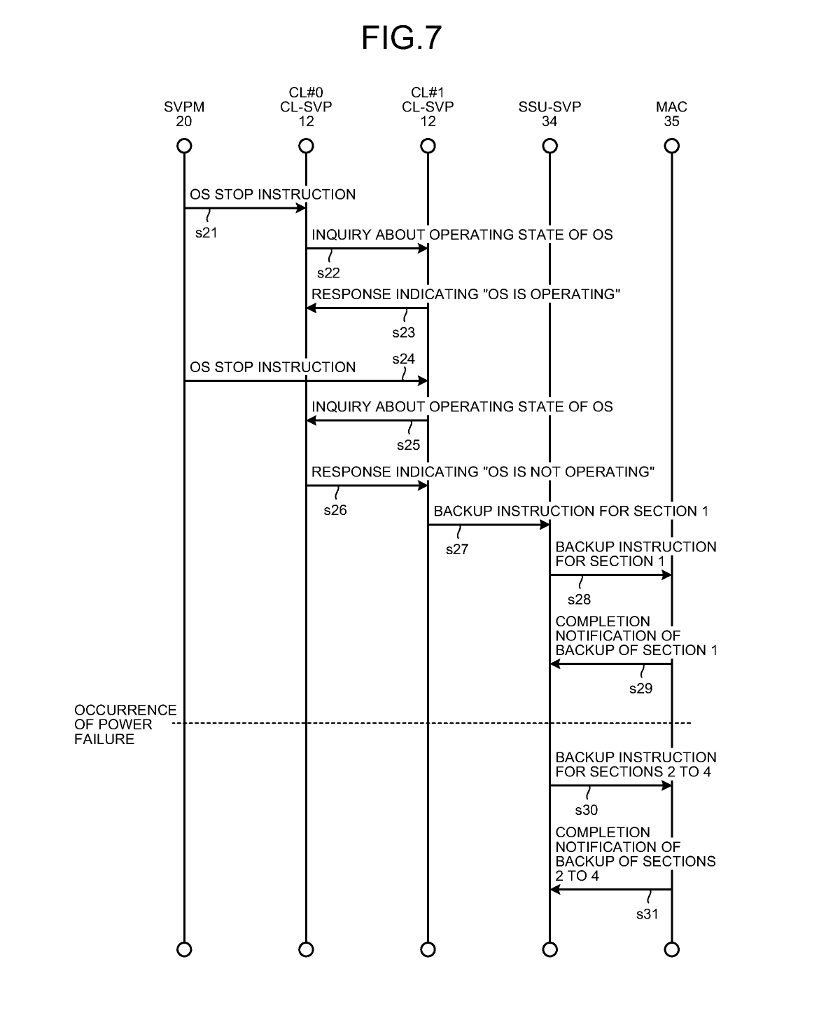

The following describes a sequence when the OSs are stopped according to the first embodiment with reference to FIG. 7. FIG. 7 is a diagram of a sequence performed when the OSs are stopped according to the first embodiment. In the example of FIG. 7, the cluster (CL) #0 and the cluster (CL) #1 are allocated to the same section 1 (Sec. 1) in the shared memory 31. The backup execution flags 34a and the backup completion flags 34b of all the sections are set to “OFF”.

The SVPM 20 transmits a stop instruction for the OS to the CL control unit (CL-SVP) 12 of the CL #0 (s21). The CL-SVP 12 of the CL #0 receives the stop instruction and inquires of the CL-SVP 12 of the CL #1 allocated to the same section about the operating state of the OS (s22). Because the OS is operating on the CL-SVP 12 of the CL #1, the CL-SVP 12 of the CL #1 transmits a response indicating that “the OS is operating” to the CL #0 (s23). The CL-SVP 12 of the CL #0 then completes stopping the OS.

Subsequently, the SVPM 20 transmits a stop instruction for the OS to the CL control unit (CL-SVP) 12 of the CL #1 (s24). The CL-SVP 12 of the CL #1 receives the stop instruction and inquires of the CL-SVP 12 of the CL #0 allocated to the same section about the operating state of the OS (s25). Because the OS is stopped in the CL-SVP 12 of the CL #0, the CL-SVP 12 of the CL #0 transmits a response indicating that “the OS is not operating” to the CL #1 (s26). Subsequently, the CL-SVP 12 of the CL #1 transmits a backup instruction for the section 1 to the SSU control unit (SSU-SVP) 34 via the maintenance line 50 (s27). The CL-SVP 12 of the CL #1 then completes stopping the OS.

The SSU-SVP 34 receives the backup instruction for the section 1. Because the backup execution flag 34a and the backup completion flag 34b of the section 1 are set to “OFF”, the SSU-SVP 34 instructs the SSD control unit (MAC) 35 to back up the section 1 (s28). The MAC 35 performs a backup of the section 1 thus instructed. After the backup is completed, the MAC 35 transmits a completion notification of the backup of the section 1 to the SSU-SVP 34 (s29). The SSU-SVP 34 receives the completion notification of the backup of the section 1. The SSU-SVP 34 then turns “ON” the backup completion flag 34b of the section 1 and turns “OFF” the backup execution flag 34a of the section 1. Thus, the backup of the section 1 is completed.

If a power failure occurs after this, the SSU-SVP 34 receives a notification that the power failure is detected and activates the auxiliary power supply 33. The SSU-SVP 34 then instructs the MAC 35 to back up the sections 2 to 4 other than the section 1 for which the backup is completed (s30). The MAC 35 performs a backup of the sections 2 to 4 thus instructed. After the backup is completed, the MAC 35 transmits a completion notification of the backup of the sections 2 to 4 to the SSU-SVP 34 (s31). The SSU-SVP 34 receives the completion notification of the backup of the sections 2 to 4. The SSU-SVP 34 then turns “ON” the backup completion flags 34b of the sections 2 to 4 and turns “OFF” the backup execution flags 34a of the sections. Thus, the backup of all the sections of the shared memory 31 is completed. The SSU-SVP 34 then causes the shared memory device (SSU) 30 to stop operating.

Advantageous Effects of First Embodiment

According to the first embodiment, the information processing system 1 includes the clusters 10-1 to 10-n and the shared memory device 30 having a plurality of sections. During the operation of the system, the shared memory device 30 detects the stop of the OSs operating on all the clusters allocated to a certain section among the sections of the shared memory 31 allocated to the clusters 10-1 to 10-n. In addition, when detecting the stop of the OSs operating on all the clusters allocated to the certain section, the shared memory device 30 backs up data stored in the certain section to the nonvolatile storage unit 32. With this configuration, if it is detected that the OSs operating on all the clusters allocated to the certain section are stopped, the information processing system 1 keeps the section from being accessed after the detection. This prevents the data stored in the section from being rewritten. The information processing system 1 backs up in advance the data stored in the section not to be rewritten to the nonvolatile storage unit 32 during the operation of the system. Thus, the information processing system 1 can reduce the amount of data backed up when a power failure occurs. In other words, the information processing system 1 can reduce the amount of data backed up when a power failure occurs compared with the case of backing up data of all the sections when a power failure occurs.

According to the first embodiment, the information processing system 1 supplies power to the shared memory device 30 from the auxiliary power supply 33 when a power failure occurs. Thus, the information processing system 1 backs up data stored in sections other than the certain section to the nonvolatile storage unit 32. With this configuration, the information processing system 1 backs up the data stored in the sections other than the certain section to the nonvolatile storage unit 32 with power supplied from the auxiliary power supply 33 when a power failure occurs. This enables the information processing system 1 to reduce the amount of data backed up when a power failure occurs by the amount of data stored in the certain section. As a result, the information processing system 1 can reduce time required to perform the backup when a power failure occurs.

According to the first embodiment, if a stop instruction for the OS is received, the cluster 10-1 determines whether the OSs of all the clusters allocated to the same certain section as that for the cluster 10-1 are operating. If it is determined that all the OSs that operate on all the clusters allocated to the same certain section as that for the cluster 10-1 are not operating, the cluster 10-1 transmits a backup instruction for the certain section to the shared memory device 30. The shared memory device 30 receives the backup instruction for the certain section from the cluster 10-1, thereby detecting that the OSs operating on all the clusters allocated to the certain section are stopped. With this configuration, if the cluster 10-1 receives a stop instruction of the OS and determines that all the OSs that operate on all the clusters allocated to the same certain section as that for the cluster 10-1 are not operating, the cluster 10-1 transmits a backup instruction for the certain section to the shared memory device 30. This enables the shared memory device 30 to back up the section at the same time as the data stored in the certain section is kept from being rewritten. Thus, the shared memory device 30 can back up the data reliably at an early stage before a power failure occurs.

In the first embodiment, the shared memory device 30 detects the stop of the OSs operating on all the clusters allocated to a certain section among the sections of the shared memory 31 during the operation of the system. The target of the detection, however, is not limited to the OSs. The shared memory device 30 may detect stop of computer programs operating on all the clusters allocated to a certain section among the sections of the shared memory 31. In other words, the shared memory 31 may be a memory shared by computer programs operating on a plurality of clusters. In this case, when detecting that the computer programs operating on all the clusters allocated to the certain section are stopped, the shared memory device 30 backs up data stored in the certain section to the nonvolatile storage unit 32.

### [b] Second Embodiment

Configuration of Information Processing System According to Second Embodiment

When all the OSs operating on all the clusters allocated to the same certain section as that for the cluster for which an OS stop instruction is issued are stopped, the information processing system 1 according to the first embodiment performs backup of the section. The information processing system 1 does not necessarily perform the backup in this manner. The information processing system 1 may inquire of the monitoring device 20 about the operating state of the OSs of the clusters. In this case, if the OSs of all the clusters allocated to a certain section stop operating, the information processing system 1 may perform the backup of the section.

In a second embodiment, an information processing system 2 inquires of a monitoring device 20 about the operating state of OSs of clusters. If the OSs of all the clusters allocated to a certain section stop operating, the information processing system 2 performs a backup of the section.

Configuration of Information Processing System According to Second Embodiment

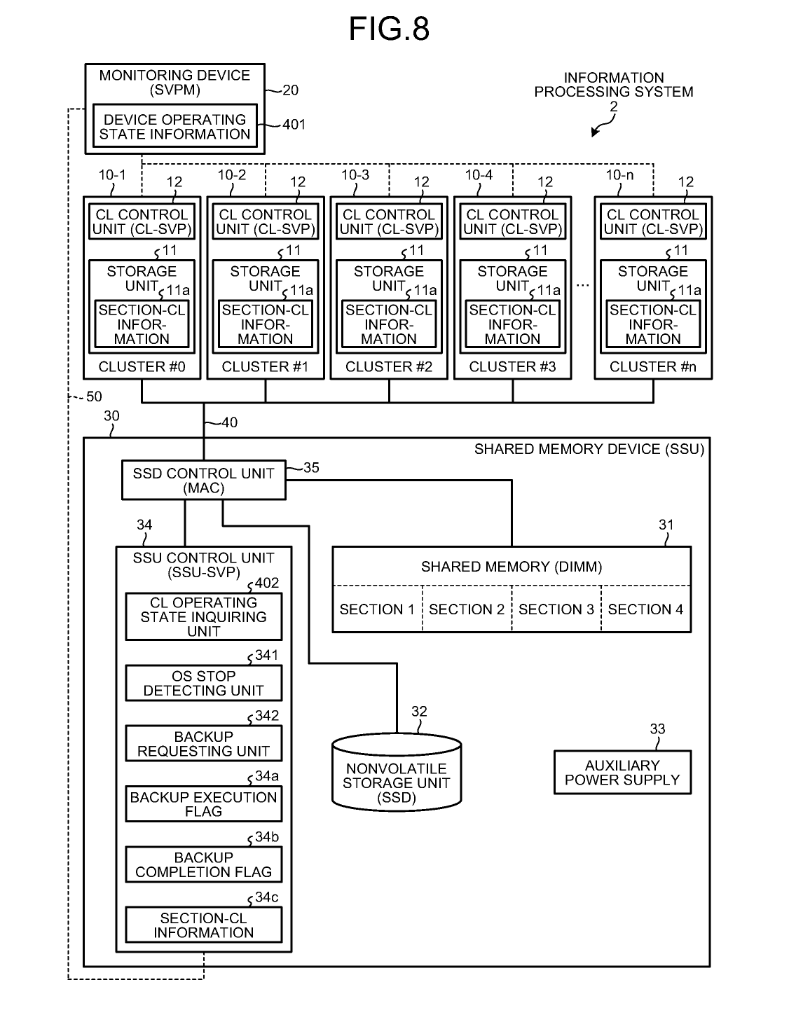

FIG. 8 is a functional block diagram of a configuration of the information processing system 2 according to the second embodiment. Components similar to those in the information processing system 1 illustrated in FIG. 1 are denoted by like reference numerals. Overlapping explanations of the configuration and the operation are omitted. The second embodiment is different from the first embodiment in that device operating state information 401 is added to the monitoring device 20. Furthermore, the second embodiment is different from the first embodiment in that a CL operating state inquiring unit 402 is added to an SSU control unit 34.

The device operating state information 401 associates the operating state with each device. The device operating state information 401, for example, stores therein information indicating whether the operating state is a state supplied with power (referred to as a “power ready state”) in association with all clusters 10-1 to 10-n and a shared memory device 30. The monitoring device 20 regularly monitors the power ready state of all the clusters 10-1 to 10-n and the shared memory device 30, thereby storing information indicating whether each device is in the power ready state in the device operating state information 401.

The CL operating state inquiring unit 402 regularly inquires of the monitoring device 20 about the operating state of the OSs of the clusters.

During an operation of the system, the OS stop detecting unit 341 detects that OSs of all clusters allocated to a certain section stop operating. The OS stop detecting unit 341, for example, detects that all the clusters using a certain section stop operating based on the operating state of the OSs of the clusters and the section-CL information 34c. The operating state of the OSs of the clusters is obtained as a result of inquiry made by the CL operating state inquiring unit 402. In other words, the OS stop detecting unit 341 detects that all the clusters using the certain section are in a power cut state, which is not the power ready state. The backup requesting unit 342 then performs request processing for a backup of the section related to the detection.

Process Performed by SSU Control Unit (SSU-SVP) When OSs Are Stopped According to Second Embodiment

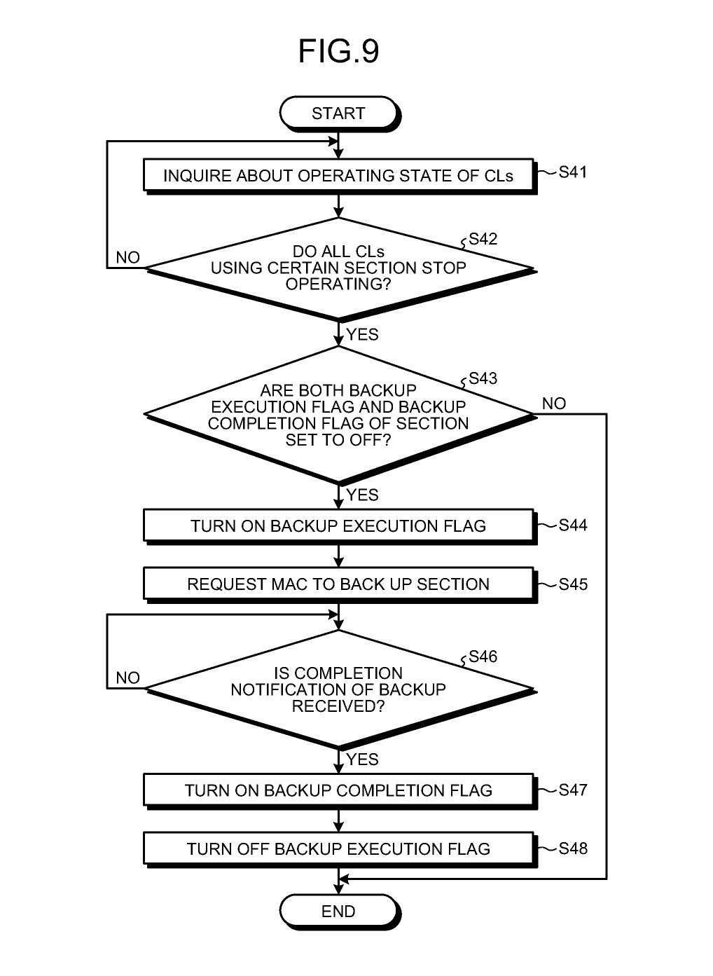

The following describes a process performed by the SSU control unit (SSU-SVP) 34 when OSs are stopped according to the second embodiment with reference to FIG. 9. FIG. 9 is a flowchart of a process performed by the SSU control unit (SSU-SVP) when the OSs are stopped according to the second embodiment.

The CL operating state inquiring unit 402 of the SSU-SVP 34 regularly inquires of the monitoring device (SVPM) 20 about the operating state of the CLs 10-1 to 10-n (Step S41). The OS stop detecting unit 341 determines whether all the clusters 10 using a certain section stop operating (Step S42). The OS stop detecting unit 341, for example, determines whether all the clusters 10 using a certain section stop operating based on the operating state of the clusters 10 obtained as a result of the inquiry and on the section-CL information 34c.

If it is determined that any of the clusters 10 using the certain section does not stop operating (No at Step S42), the OS stop detecting unit 341 repeats the processing at Step S41 so as to continuously inquire the operating state of the clusters 10. By contrast, if it is determined that all the clusters 10 using the certain section stop operating (Yes at Step S42), the OS stop detecting unit 341 detects that all the clusters 10 using the certain section stop operating.

Subsequently, the backup requesting unit 342 determines whether both the backup execution flag 34a and the backup completion flag 34b of the section are set to OFF (Step S43). If both the backup execution flag 34a and the backup completion flag 34b are not set to OFF (No at Step S43), the backup requesting unit 342 is executing a backup or completes a backup. Thus, the processing is terminated.

By contrast, if both the backup execution flag 34a and the backup completion flag 34b are set to OFF (Yes at Step S43), the backup requesting unit 342 turns “ON” the backup execution flag 34a of the section for which a backup instruction is issued (Step S44). The backup requesting unit 342 requests an SSD control unit 35 to back up the section (Step S45).

Subsequently, the backup requesting unit 342 determines whether a completion notification of the backup of the section serving as the target of the backup is received (Step S46). If it is determined that no completion notification of the backup is received (No at Step S46), the backup requesting unit 342 repeats the determination processing until a completion notification of the backup is received. By contrast, if it is determined that a completion notification of the backup is received (Yes at Step S46), the backup requesting unit 342 turns “ON” the backup completion flag of the section serving as the target of the backup (Step S47). The backup requesting unit 342 then turns “OFF” the backup execution flag of the section serving as the target of the backup (Step S48).

Process Performed by SSU Control Unit (SSU-SVP) When Power Failure Occurs According to Second Embodiment

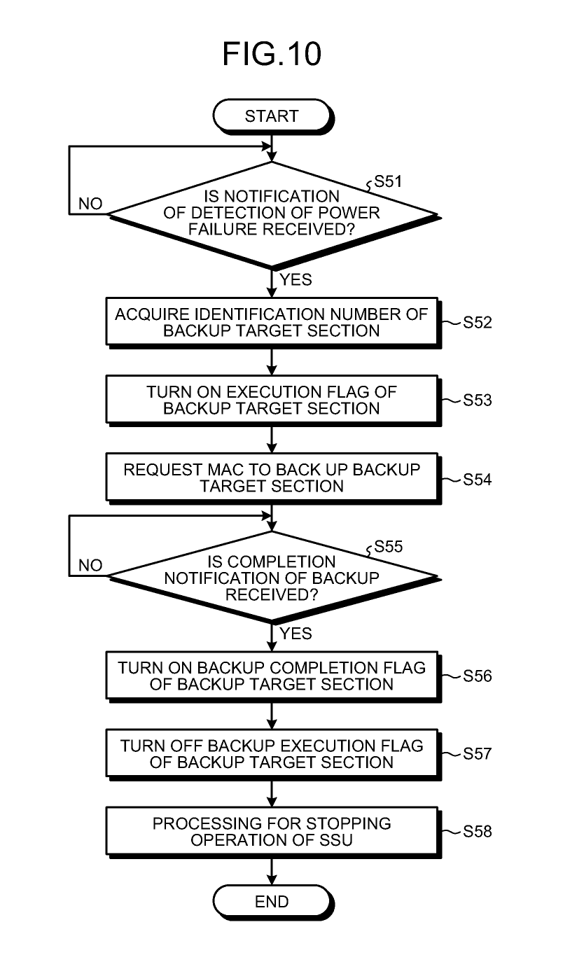

FIG. 10 is a flowchart of a process performed by the SSU control unit (SSU-SVP) when a power failure occurs according to the second embodiment. Because the process performed by the SSU-SVP when a power failure occurs according to the second embodiment is the same as that according to the first embodiment, the explanation thereof is omitted.

Data Flow When OSs Are Stopped According to Second Embodiment

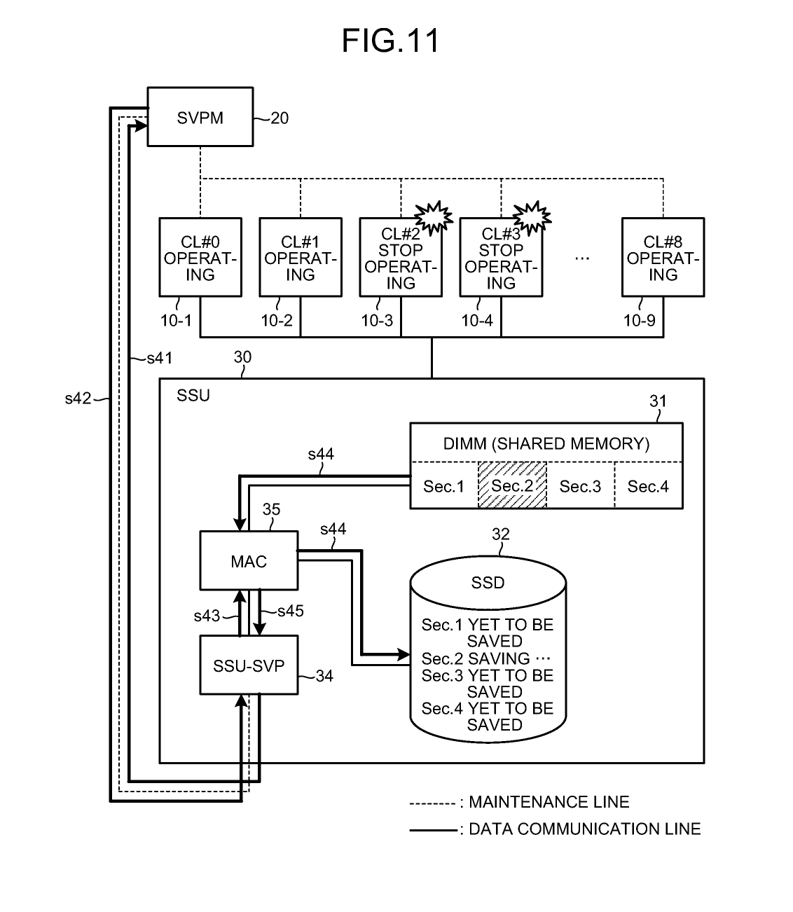

The following describes a data flow when the OSs are stopped according to the second embodiment with reference to FIG. 11. FIG. 11 is a view for explaining a data flow when the OSs are stopped according to the second embodiment. In the example of FIG. 11, a cluster 10-3 (CL #2) and a cluster 10-4 (CL #3) allocated to the same section 2 (Sec. 2) of the shared memory 31 suddenly stop operating because of a partial power failure. The backup execution flags 34a and the backup completion flags 34b of all the sections are set to “OFF”.

The SSU control unit (SSU-SVP) 34 regularly inquires of the monitoring device (SVPM) 20 about the operating state of the clusters 10-1 to 10-9 (s41). In response to the inquiry made by the SSU-SVP 34, the SVPM 20 transmits the fact that the CL #2 and the CL #3 stop operating (s42).

Subsequently, the SSU-SVP 34 receives the fact that the CL #2 and the CL #3 stop operating and checks that all the OSs using the section 2 to which the CL #2 and the CL #3 are allocated are stopped. This keeps data stored in the section 2 of the shared memory 31 from being accessed.

Subsequently, the SSU-SVP 34 checks that the backup execution flag 34a and the backup completion flag 34b of the section 2 are set to “OFF”. Because the backup execution flag 34a and the backup completion flag 34b of the section 2 are set to “OFF”, the SSU-SVP 34 turns “ON” the backup execution flag 34a of the section 2, which indicates that “data is being saved”. The SSU-SVP 34 then transmits a backup instruction for the section 2 to the SSD control unit (MAC) 35 (s43).

If the backup instruction for the section 2 is received, the MAC 35 reads the data stored in the section 2 of the shared memory 31 from the shared memory 31 and backs up the data thus read to the nonvolatile storage unit (SSD) 32 (s44). After the backup is completed, the MAC 35 transmits a completion notification of the backup of the section 2 to the SSU-SVP 34 (s45). After receiving the completion notification of the backup, the SSU-SVP 34 turns “ON” the backup completion flag 34b of the section 2 and turns “OFF” the backup execution flag 34a of the section 2.

Data Flow When Power Failure Occurs According to Second Embodiment

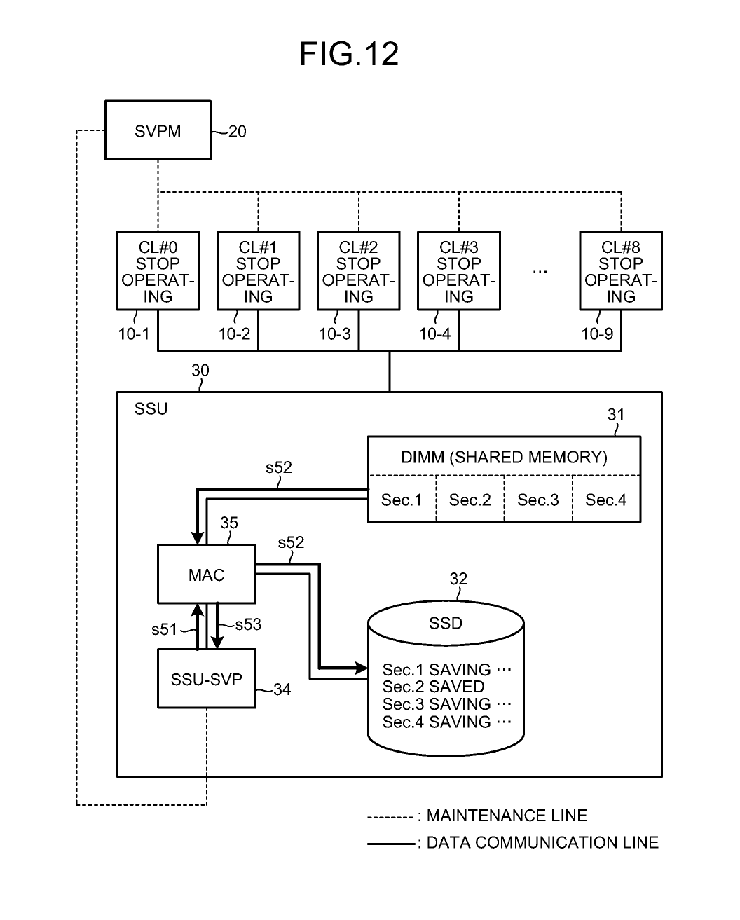

The following describes a data flow when a power failure occurs according to the second embodiment with reference to FIG. 12. FIG. 12 is a view for explaining a data flow when a power failure occurs according to the second embodiment. In the example of FIG. 12, the backup completion flag 34b of the section 2 (Sec. 2) is set to “ON”, which indicates that “data is saved”, and the backup completion flags 34b of the sections other than the section 2 are set to “OFF”. The backup execution flags 34a of all the sections are set to “OFF”.

If a power failure occurs, the SSU control unit (SSU-SVP) 34 of the SSU 30 receives a notification that the power failure is detected. Because the backup execution flags 34a and the backup completion flags 34b of the sections other than the section 2 are set to “OFF”, the SSU-SVP 34 acquires sections 1, 3, and 4 other than the section 2. The SSU-SVP 34 turns “ON” the backup execution flags 34a of the sections 1, 3, and 4, which indicates that “data is being saved”, and transmits a backup instruction for the sections to the SSD control unit (MAC) 35 (s51).

If the backup instruction for the sections 1, 3, and 4 is received, the MAC 35 reads data stored in the sections from the shared memory 31 and backs up the data thus read to the nonvolatile storage unit (SSD) 32 (s52). After the backup is completed, the MAC 35 transmits a completion notification of the backup of the sections 1, 3, and 4 to the SSU-SVP 34 (s53). After receiving the completion notification of the backup, the SSU-SVP 34 turns “ON” the backup completion flags 34b of the sections 1, 3, and 4 and turns “OFF” the backup execution flags 34a of the sections. Subsequently, the SSU-SVP 34 stops operating.

Sequence When OSs Are Stopped According to Second Embodiment

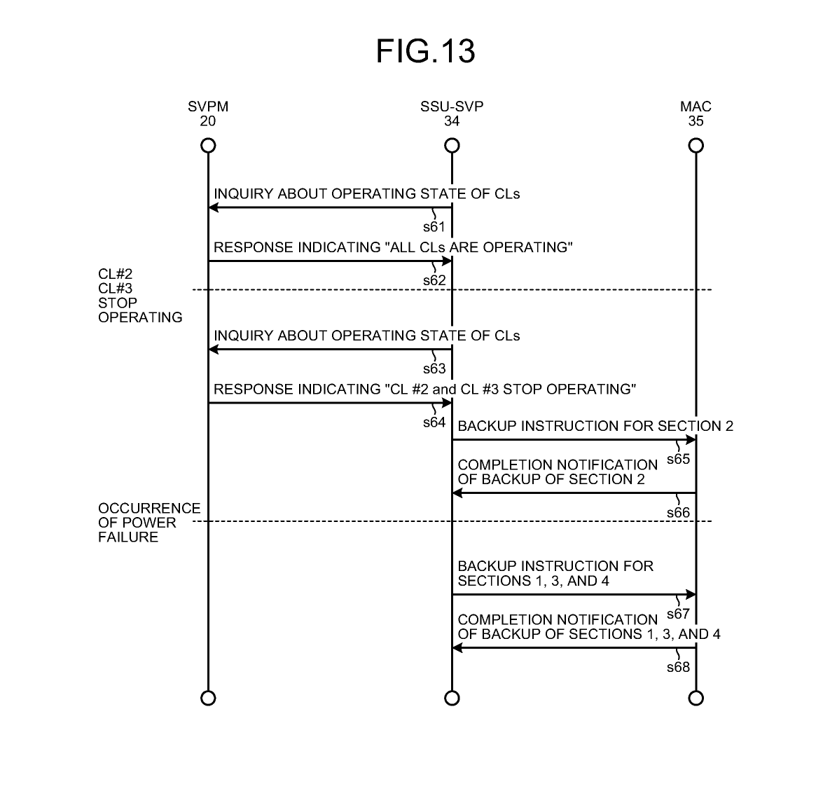

The following describes a sequence when the OSs are stopped according to the second embodiment with reference to FIG. 13. FIG. 13 is a diagram of a sequence performed when the OSs are stopped according to the second embodiment. In the example of FIG. 13, the cluster (CL) #2 and the cluster (CL) #3 are allocated to the same section 2 (Sec. 2) in the shared memory 31. The backup execution flags 34a and the backup completion flags 34b of all the sections are set to “OFF”.

An assumption is made that all the CLs are operating. The SSU control unit (SSU-SVP) 34 inquires of the monitoring device (SVPM) 20 about the operating state of all the CLs (s61). Because all the CLs are operating, the SVPM 20 transmits a response indicating that all the CLs are operating (s62).

An assumption is made that the CL #2 and the CL #3 among all the CLs stop operating. The SSU control unit (SSU-SVP) 34 inquires of the monitoring device (SVPM) 20 about the operating state of all the CLs (s63). Because the CL #2 and the CL #3 stop operating, the SVPM 20 transmits a response indicating that the CL #2 and the CL #3 stop operating (s64).

The SSU-SVP 34 receives the response indicating that the CL #2 and the CL #3 stop operating, thereby detecting that all the clusters using the section 2 stop operating. Because the backup execution flag 34a and the backup completion flag 34b of the section 2 are set to “OFF”, the SSU-SVP 34 instructs the SSD control unit (MAC) 35 to back up the section 2 (s65). The MAC 35 performs a backup of the section 2 thus instructed. After the backup is completed, the MAC 35 transmits a completion notification of the backup of the section 2 to the SSU-SVP 34 (s66). The SSU-SVP 34 receives the completion notification of the backup of the section 2. The SSU-SVP 34 then turns “ON” the backup completion flag 34b of the section 2 and turns “OFF” the backup execution flag 34a of the section 2. Thus, the backup of the section 2 is completed.

If a power failure occurs after this, the SSU-SVP 34 receives a notification that the power failure is detected and activates the auxiliary power supply 33. The SSU-SVP 34 then instructs the MAC 35 to back up the sections 1, 3, and 4 other than the section 2 for which the backup is completed (s67). The MAC 35 performs a backup of the sections 1, 3, and 4 thus instructed. After the backup is completed, the MAC 35 transmits a completion notification of the backup of the sections 1, 3, and 4 to the SSU-SVP 34 (s68). The SSU-SVP 34 receives the completion notification of the backup of the sections 1, 3, and 4. The SSU-SVP 34 then turns “ON” the backup completion flags 34b of the sections 1, 3, and 4 and turns “OFF” the backup execution flags 34a of the sections. Thus, the backup of all the sections of the shared memory 31 is completed. The SSU-SVP 34 then causes the shared memory device (SSU) 30 to stop operating.

Advantageous Effects of Second Embodiment

According to the second embodiment, the information processing system 2 includes the clusters 10-1 to 10-n and the shared memory device 30 having a plurality of sections. The information processing system 2 further includes the monitoring device 20 that monitors the operating state of the OSs operating on the clusters 10-1 to 10-n. The shared memory device 30 inquires of the monitoring device 20 about the operating state of the OSs operating on the clusters and detects that OSs operating on all the clusters allocated to a certain section stop operating. In addition, when detecting that the OSs operating on all the clusters allocated to the certain section stop operating, the shared memory device 30 backs up data stored in the certain section to the nonvolatile storage unit 32. With this configuration, if it is detected that the OSs operating on all the clusters allocated to the certain section stop operating, the information processing system 2 keeps the section from being accessed after the detection. This prevents the data stored in the section from being rewritten. The information processing system 2 backs up in advance the data stored in the section not to be rewritten to the nonvolatile storage unit 32 during the operation of the system. Thus, the information processing system 2 can reduce the amount of data backed up when a power failure occurs. In other words, the information processing system 2 can reduce the amount of data backed up when a power failure occurs compared with the case of backing up data of all the sections when a power failure occurs.

In the second embodiment, the shared memory device 30 inquires of the monitoring device 20 about the operating state of the OSs operating on the clusters and detects that OSs operating on all the clusters allocated to a certain section stop operating. The target of the detection, however, is not limited to the OSs. The shared memory device 30 may inquire of the monitoring device 20 about the operating state of computer programs operating on the clusters and detect that computer programs operating on all the clusters allocated to a certain section stop operating. In this case, when detecting that the computer programs operating on all the clusters allocated to the certain section stop operating, the shared memory device 30 backs up data stored in the certain section to the nonvolatile storage unit 32.

Others

The clusters 10-1 to 10-n each can be provided as a known information processing apparatus, such as a personal computer and a workstation, equipped with the functions described above including the CL control unit 12. The shared memory device 30 can be provided as a known information processing apparatus, such as a personal computer and a workstation, equipped with the functions described above including the OS stop detecting unit 341 and the backup requesting unit 342. The monitoring device 20 can be provided as a known information processing apparatus, such as a personal computer and a workstation, equipped with the functions described above. The information processing apparatuses that function as the clusters 10-1 to 10-n, the shared memory device 30, and the monitoring device 20 each include a CPU, a storage device, such as a RAM and a hard disk, a network interface, and a medium reading device, for example.

The components of each device illustrated in the drawings are not necessarily physically configured as illustrated. In other words, the specific aspects of distribution and integration of each device are not limited to those illustrated in the drawings. The whole or a part thereof may be distributed or integrated functionally or physically in arbitrary units depending on various types of loads and usages, for example. The OS stop detecting unit 341 and the backup requesting unit 342 may be integrated as a single unit, for example. The backup requesting unit 342 may be distributed into a first requesting unit and a second requesting unit. The first requesting unit requests the SSD control unit 35 to back up a section for which a backup instruction is issued, whereas the second requesting unit requests the SSD control unit 35 to back up an appropriate section after a power failure is detected. The nonvolatile storage unit 32 may be provided as an external device of the shared memory device 30 and be connected thereto via a network.

The whole or an arbitrary part of processing functions performed in the information processing systems 1 and 2 may be carried out by a CPU (or a microcomputer, such as a micro processing unit (MPU) and a micro controller unit (MCU)) or wired-logic hardware. Furthermore, the whole or an arbitrary part of processing functions performed in the information processing systems 1 and 2 may be carried out by computer programs analyzed and executed by a CPU (or a microcomputer, such as an MPU and an MCU).

An aspect of the information processing system according to the present disclosure can reduce time required to back up data on the memory area of the shared memory device when a power failure occurs.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a plurality of information processing apparatuses; and
a shared memory device including a shared memory shared by computer programs that operate on the information processing apparatuses, wherein
the shared memory device includes:
a detecting unit that detects stop of computer programs that operate on all information processing apparatuses allocated to a certain storage area among storage areas of the shared memory shared by the information processing apparatuses during an operation of the information processing system; and
a saving unit that saves, when the detecting unit detects the stop of the computer programs that operate on all the information processing apparatuses allocated to the certain storage area, data stored in the certain storage area to a nonvolatile storage area.

2. The information processing system according to claim 1, wherein when a power failure occurs, the saving unit supplies power to the shared memory device by a backup power supply and saves data stored in a storage area different from the certain storage area to the nonvolatile storage area.

3. The information processing system according to claim 1, wherein
the each information processing apparatus includes a control unit that determines, when a stop instruction for the computer programs that operate on the information processing apparatus is acquired, whether the computer programs that operate on all the information processing apparatuses allocated to the certain storage area same as that of the information processing apparatus are operating, and when determining that all the computer programs that operate on all the information processing apparatuses are not operating, transmits a saving instruction for saving the data stored in the certain storage area to the nonvolatile storage area to the shared memory device, and
the detecting unit acquires the saving instruction transmitted from the control unit, thereby detects that the computer programs that operate on all the information processing apparatuses allocated to the certain storage area are stopped.

4. The information processing system according to claim 1, further comprising:
a monitoring unit that monitors an operating state of the computer programs that operate on the information processing apparatuses, wherein
the detecting unit inquires of the monitoring device about the operating state of the computer programs that operate on the information processing apparatuses and detects that the computer programs that operate on all the information processing apparatuses allocated to the certain storage area stop operating.

5. A shared memory device comprising:
a shared memory shared by computer programs that operate on a plurality of information processing apparatuses;
a detecting unit that detects stop of computer programs that operate on all information processing apparatuses allocated to a certain storage area among storage areas of the shared memory shared by the information processing apparatuses during an operation of a system; and
a saving unit that saves, when the detecting unit detects the stop of the computer programs that operate on all the information processing apparatuses allocated to the certain storage area, data stored in the certain storage area to a nonvolatile storage area.

6. A method for saving memory data performed by an information processing system including a plurality of information processing apparatuses and a shared memory shared by computer programs that operate on the information processing apparatuses, the method comprising:
detecting stop of computer programs that operate on all information processing apparatuses allocated to a certain storage area among storage areas of the shared memory shared by the information processing apparatuses during an operation of the information processing system; and
saving, when the stop of the computer programs that operate on all the information processing apparatuses allocated to the certain storage area is detected at the detecting, data stored in the certain storage area to a nonvolatile storage area.
